(19) United States
(12) Patent Application Publication
(10) Pub. No.: US 2022/0027530 A1
(43) Pub. Date: Jan. 27, 2022

(54) METHOD OF MODELING PART OF SHOE AND METHOD OF SHOE DESIGNING

(71) Applicant: DAH LIH PUH CO., LTD., Taichung City (TW)

(72) Inventor: Jui-Fen SHIAO, TAICHUNG CITY (TW)

(21) Appl. No.: 17/033,908

(22) Filed: Sep. 27, 2020

(30) Foreign Application Priority Data
Jul. 23, 2020 (TW) 109124999

(51) Int. Cl. G06F 30/12; G06F 30/20; G06T 15/04; G06T 17/00; G06T 19/20; G06T 19/00; B29C 64/393; B33Y 50/02

(52) U.S. Cl. CPC G06F 30/12; G06F 30/20; G06T 15/04; B33Y 50/02; G06T 19/20; G06T 19/006; B29C 64/393; G06T 17/00

(57) ABSTRACT

According to one aspect of the present disclosure, a method of modeling part of shoe includes steps as follows. A shoe sample is provided, a modeling step is performed, a mapping step is performed, a dividing step is performed and a transferring step is performed. In the modeling step, the shoe sample is 3D-scanned to establish a structural model. In the mapping step, a plurality of shoe texture photos are shot from the shoe sample, and the plurality of shoe texture photos are mapped to the structural model, so as to form a shoe model with a texture. In the dividing step, the structural model is divided into at least two part prototypes according to the texture of the shoe model. In the transferring step, the texture of the shoe model is transferred to the at least two part prototypes to form at least two part models.

### RELATED APPLICATIONS

This application claims priority to Taiwan Application Serial Number 109124999, filed Jul. 23, 2020, which is herein incorporated by reference.

### BACKGROUND

### Technical Field

The present disclosure relates to a method of 3D modeling. More particularly, the present disclosure relates to a method of establishing 3D models of parts of a shoe.

### Description of Related Art

Due to the development of 3D drafting technology, it has gradually changed the design of footwear from drafting 2D technical drawings to creating 3D models by computers. When a shoe is designed by 2D drawings, it was difficult for the designer to imagine the 3D construction of the finished shoe. Therefore, the finished shoe usually falls short of the designer's requirements, which needs repeating building and correcting shoe prototypes to make the finished shoe meet the requirements. Conversely, when a shoe is designed by 3D drafting technique, the designer can predict the construction of the finished shoe by observing the 3D model. The designer can modify the 3D model and build the shoe prototype after the 3D model meets the requirements, so as to reduce the duplicated process of building the shoe prototypes.

At present, the 3D models of shoes are mostly established manually in the shoe industry, that is, the modeler draws the 3D models according to the products or the 2D technical drawings of the shoes. By this modeling method, the efficiency of creating the 3D models is relatively low. The accuracy of the 3D models usually depends on the skill of the modeler, and the surface texture of the shoes is difficult to be presented on the 3D models, resulting in a significant difference between the 3D models and the shoe products. Furthermore, if the designer wants to use the specific parts (such as the upper or the outsole) of existing 3D shoe models when designing a new shoe, the designer must use 3D drafting software to divide and copy the specific parts of the existing 3D shoe models for reassembling, which is quite inconvenient for the designer without 3D drafting skills.

In this regard, it is still an unsolved problem to enhance the quality and creating efficiency of the 3D models of shoes, and to improve the convenience of designing a shoe.

### SUMMARY

According to one aspect of the present disclosure, a method of modeling part of shoe includes steps as follows. A shoe sample is provided, a modeling step is performed, a mapping step is performed, a dividing step is performed and a transferring step is performed. In the modeling step, the shoe sample is 3D-scanned to establish a structural model. In the mapping step, a plurality of shoe texture photos are shot from the shoe sample, and the plurality of shoe texture photos are mapped to the structural model, so as to form a shoe model with a texture. In the dividing step, the structural model is divided into at least two part prototypes according to the texture of the shoe model. In the transferring step, the texture of the shoe model is transferred to the at least two part prototypes to form at least two part models.

According to another aspect of the present disclosure, a method of shoe designing includes steps as follows. A database is provided, a designing step is performed and an outputting step is performed. The database includes a plurality of part models established from a plurality of shoe samples and includes a plurality of shoe models, where the database is created by the aforementioned method of modeling part of shoe. In the designing step, at least two of the part models which are suitable are chosen from the database and assembled, or one of the shoe models are chosen from the database and the texture or a structure of the one of the shoe models is modified, so as to form a design shoe model. In the outputting step, the design shoe model is output.

### BRIEF DESCRIPTION OF THE DRAWINGS

The present disclosure can be more fully understood by reading the following detailed description of the embodiment, with reference made to the accompanying drawings as follows:

FIG. 1 is a flow chart of a method of modeling part of shoe according to one aspect of the present disclosure.

FIG. 2 is a schematic view of different steps of the method of FIG. 1.

FIG. 3 is a flow chat of Step 140 of the method of FIG. 1.

FIG. 4A is a three-dimensional schematic view of a 3D shoe model established by a conventional 3D drafting method.

FIG. 4B is a three-dimensional schematic view of a shoe model established by the method of FIG. 1.

FIG. 5 is a flow chart of a method of shoe designing according to another aspect of the present disclosure.

FIG. 6A is a side schematic view of another shoe model established by the method of FIG. 1.

FIG. 6B is a side schematic view of the shoe model of FIG. 6A modified by the method of FIG. 5.

### DETAILED DESCRIPTION

The examples of the present disclosure will be described below with reference to the drawings. For clear explanation, many practical details will also be explained in the following description. However, it should be understood that these practical details should not be the limitation of the present disclosure. Furthermore, in order to simplify the drawings, some conventional structures and elements will be illustrated in the drawings by a simple and schematic way.

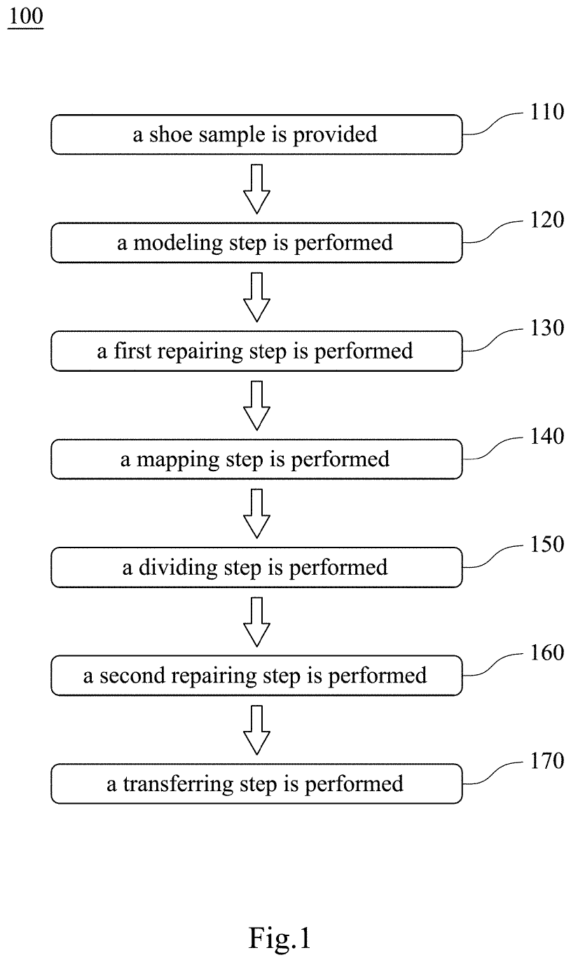

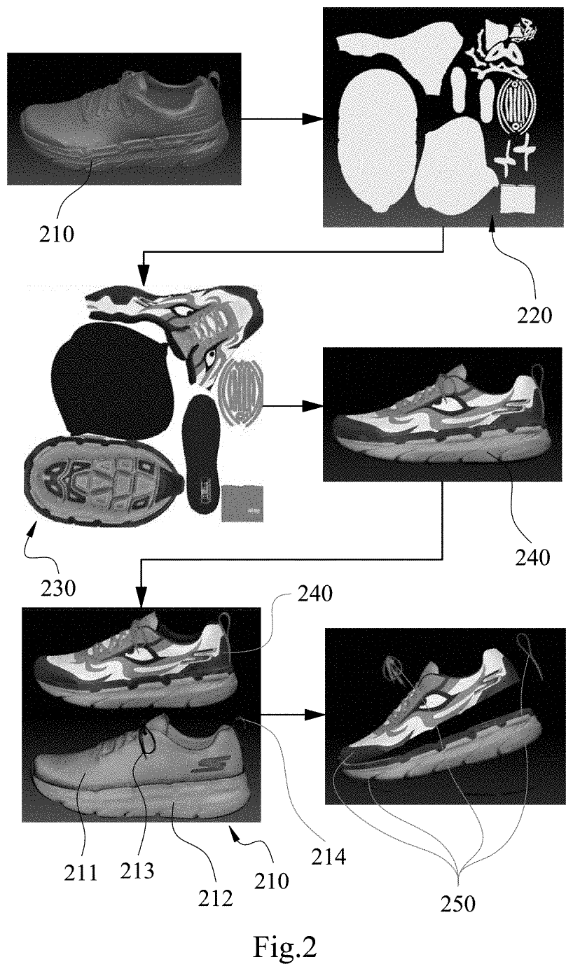

Please refer to FIG. 1 and FIG. 2. FIG. 1 is a flow chart of a method of modeling part of shoe 100 according to one aspect of the present disclosure. FIG. 2 is a schematic view of different steps of the method 100 of FIG. 1. The method of modeling part of shoe 100 includes Step 110, Step 120, Step 130, Step 140, Step 150, Step 160 and Step 170.

In Step 110, a shoe sample is provided. The shoe sample can be a shoe product already for sale or a shoe prototype built during the development of a shoe.

In Step 120, a modeling step is performed to 3D-scan the shoe sample by the 3D scanning technique, so as to establish a structural model 210. In detail, 3D scanning techniques, such as contact type scanning, non-contact type active scanning and non-contact type passive scanning, can be utilized to generate point cloud data of a surface of the shoe sample. The point cloud data is the relative position of every point of the surface of the shoe sample with reference to the scanning device, and can be imported into the relevant software to establish the structural model 210.

In Step 130, a first repairing step is performed to repair the structural model 210. Because it mainly scans the externals of the shoe sample as 3D scanning, the structural model 210 lacks the details of the interior of the shoe sample, such as the insole or the inner side of the upper. Moreover, the results of 3D scanning corresponding to the portions with specific materials or colors of the shoe sample, such as transparent or black portions, may be distorted and become defects in the structural model 210. Therefore, software such as ZBrush can be used to repair the defects, in order to reduce broken surfaces of the structural model 210, beautify the structural model 210 and reduce errors happened in further mapping or outputting.

In Step 140, a mapping step is performed. As the structural model 210 has the structure of the shoe sample but the texture such as the pattern, color or material of the externals of the shoe sample, the texture of the shoe sample is added to the structural model 210 through the mapping step. In the mapping step, a plurality of shoe texture photos are shot from the shoe sample. Then, the shoe texture photos are mapped to the structural model 210 to form a shoe model 240 with a texture. The resolution of the shoe texture photos determines the amount of detail in the texture of the shoe model 240. The resolution thereof is preferably above 4K, so the texture of the shoe sample can be highly restored on the shoe model 240.

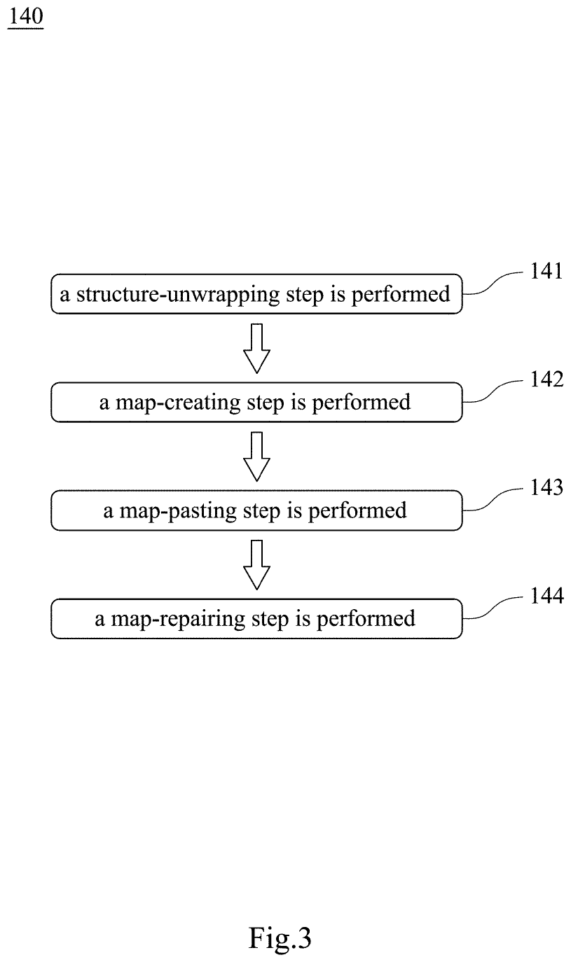

In order to combine the 2D texture information in the shoe texture photos with the 3D structural model 210, the position of the texture information on the structural model 210 must be defined before combining the texture information with the structural model 210. Thus, the possibility of misalignment or deformation of the texture can be decreased. Please refer to FIG. 2 and FIG. 3. FIG. 3 is a flow chat of Step 140 of the method 100 of FIG. 1. In FIG. 3, Step 140 includes Step 141, Step 142, Step 143 and Step 144.

In Step 141, a structure-unwrapping step is performed to 2D-unwrap the structural model 210 to establish a structural layout 220. In Step 142, a map-creating step is performed to create a shoe texture map 230 from the shoe texture photos and the structural layout 220. In detail, the structural layout 220 is an unfolded view of the structural model 210. Each point in the structural layout 220 corresponds to a point with a particular coordinate on the structural model 210. The position of the texture information on the structural model 210 can be determined by combining the shoe texture photos with the structural layout 220.

In Step 143, a map-pasting step is performed to paste the shoe texture map 230 to the structural model 210 to form the shoe model 240. Mudbox software can be used to paste the shoe texture map 230 in this step, so as to maintain the resolution of the shoe texture map 230 and increase the amount of details in the texture of the shoe model 240.

The shoe model 240 and the shoe sample can be compared after the map-pasting step. Step 144 can be performed if the shoe model 240 has insufficient accuracy or defects in the texture. In Step 144, a map-repairing step is performed to repair the shoe texture map 230, which can be done by using software such as Adobe Photoshop. The fidelity of the shoe model 240 can be enhanced by performing the map-repairing step.

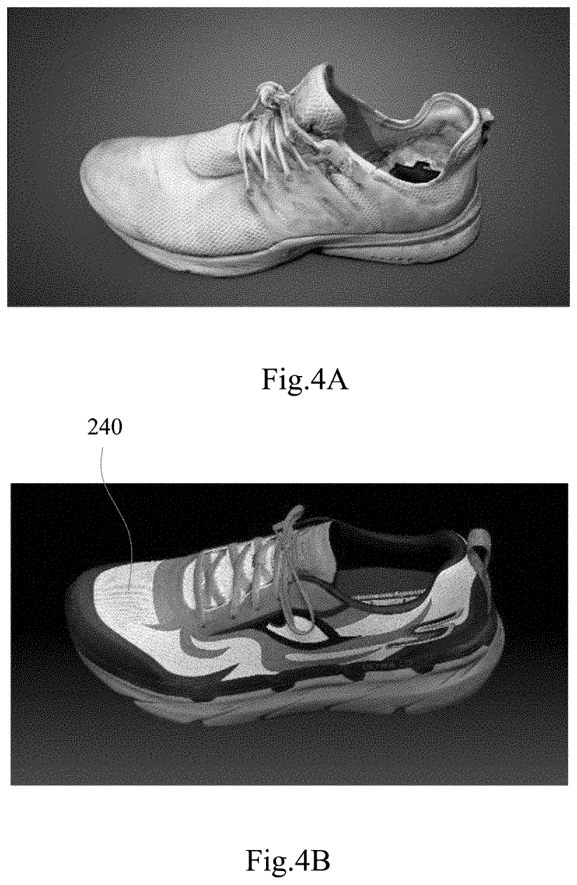

Please refer to FIG. 4A and FIG. 4B. FIG. 4A is a three-dimensional schematic view of a 3D shoe model established by a conventional 3D drafting method. FIG. 4B is a three-dimensional schematic view of a shoe model 240 established by the method 100 of FIG. 1. By comparing the models in FIG. 4A and FIG. 4B, it shows that the 3D shoe model of FIG. 4A has lower accuracy. The details of the 3D shoe model, such as the decoration on the upper and the lace, are unclear, and the internal structure thereof is incomplete. Conversely, the shoe model 240 of FIG. 4B has much more details. The pattern of the upper of the shoe model 240 is clear and the internal structure thereof is complete, which makes the shoe model 240 pretty close to a real shoe visually.

Please refer to FIG. 1 and FIG. 2. In Step 150, a dividing step is performed to divide the structural model 210. Please also refer to FIG. 4B. The details of the shoe sample are highly restored on the shoe model 240 which is established by the aforementioned mapping step, and different parts of the shoe model 240 can be easily distinguished. The edges of each part of the shoe model 240 are clear and can be taken as the dividing lines. Thus, in Step 150, the structural model 210 is divided into at least two part prototypes according to the texture of the shoe model 240. For example, the structural model 210 can be divided into an upper 211, an outsole 212, a lace 213 and a webbing 214. Furthermore, in Step 141, the structural model 210 can be 2D-unwrapped according to different parts of the shoe sample. In this regard, the structural layout 220 is divided into several part regions, and the structural model 210 can be divided according to the part regions thereof to enhance the dividing efficiency in Step 150.

In Step 160, a second repairing step is performed to repair the part prototypes formed in Step 150. Since the structure of the part prototypes divided from the structural model 210 is usually incomplete, it needs to repair the defective parts to make the structure of the part prototypes complete, which can reduce errors happened in further outputting or texture transferring. The second repairing step, the aforementioned first repairing step and the dividing step can be done by using ZBrush software.

In order to make the part prototypes have the texture of the shoe sample, the shoe texture photos can be mapped to the part prototypes, or the texture of the shoe model 240 can be transferred. However, if the texture is mapped thereto, problems such as low accuracy or texture defects may occur, and the texture quality can be enhanced only through map repairing. If the texture is transferred thereto, the aforementioned problems are reduced because the texture of the shoe model 240 has already repaired as mapping. In Step 170, a transferring step is performed to transfer the texture of the shoe model 240 to the part prototypes, in order to form at least two part models 250. Software such as Wrap 3 can be used to transfer the texture, and the shoe texture map 230 created in Step 142 can be directly transferred to the part prototypes, which can improve the efficiency of establishing the part models 250.

The method of modeling part of shoe 100 of the present disclosure can further include an organizing step, which is performed to number, categorize and save each of the part models 250 and/or the shoe model 240 into a database, facilitating searching for the specific part models 250 and/or shoe model 240. The database can be coupled with other systems, such as a designing system or a display system, in order to assemble, modify or present the part models 250 and/or the shoe model 240.

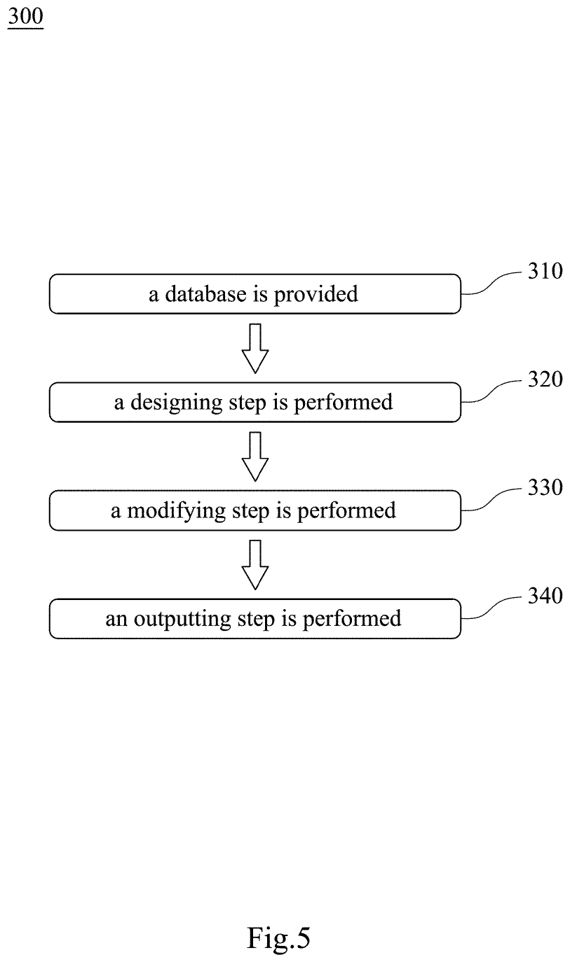

Please refer to FIG. 5. FIG. 5 is a flow chart of a method of shoe designing 300 according to another aspect of the present disclosure. The method of shoe designing 300 includes Step 310, Step 320, Step 330 and Step 340.

In Step 310, the database created by the aforementioned method of modeling part of shoe is provided. The database includes the part models established from a plurality of shoe samples and includes a plurality of shoe models. On the other hand, different types of part models and shoe models can be saved into the database. These models can be categorized according to the function thereof, for example, the models can be categorized into running shoes, basketball shoes or tennis shoes. The user can quickly find the desired model by choosing the types of shoes when designing a shoe.

In Step 320, a designing step is performed for the user to choose the suitable part models from the database and assemble the part models into a design shoe model, or to choose the suitable shoe model from the database and modify the texture or a structure thereof to form a design shoe model.

For example, the user is able to design a shoe by designing software which is coupled with the database and reads the part models and the shoe models in the database. When the user chooses a specific type of shoes, the designing software loads the models belonging to the specific type from the database and shows the models to the user. If the user chooses multiple part models, the designing software can assemble the chosen part models into a design shoe model. If the user chooses a shoe model, the chosen shoe model can be modified into a desired design shoe model by the designing software.

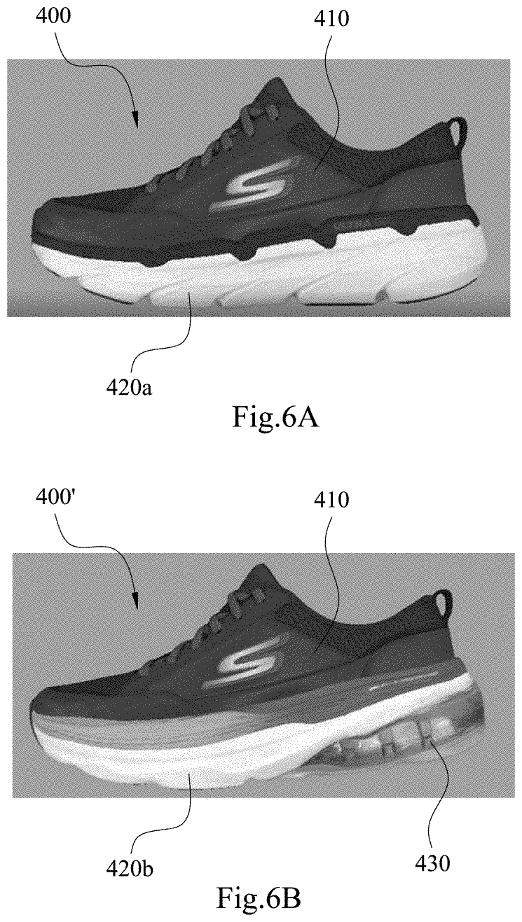

Please refer to FIG. 6A and FIG. 6B. FIG. 6A is a side schematic view of another shoe model 400 established by the method 100 of FIG. 1. FIG. 6B is a side schematic view of the shoe model 400 of FIG. 6A modified by the method 300 of FIG. 5. The shoe model 400 of FIG. 6A includes an upper 410 and an outsole 420a. The design shoe model 400′ of FIG. 6B includes the same upper 410 combining with a different outsole 420b and a damping heel 430. In FIG. 6A and FIG. 6B, it shows that the user can change or add various parts to form the unique design shoe model 400′ by the method of shoe designing 300 of the present disclosure.

In Step 330, a modifying step is performed to modify a texture or a structure of the design shoe model. The design shoe model formed in Step 320 is a preliminary result, and users can further modify the design shoe model. For example, the pattern, color and even structure of the design shoe model can be modified. Please note that the modified model can be saved into the database, and can be directly chosen from the database if needed, which means it does not need to modify the design shoe model again to get the modified model.

In Step 340, an outputting step is performed to output the design shoe model. The design shoe model can be rendered in the outputting step, in order for users freely observing the design shoe model on the designing software. The outputting step can also be a 3D-printing step, a simulating step or a virtual reality experiencing step, and these steps with different outputting methods will be introduced below.

If the outputting step is the 3D-printing step, the design shoe model can be 3D printed into a design shoe sample, so users can check the design shoe sample and understand the shoe structure designed by their own. In a conventional process, the shoe prototypes are made by the specialists in the shoe factory according to the design drawings provided by the users. If the 3D-printing step is performed, the users can print the design shoe sample by a 3D printer without the help of the specialists in the shoe factory, which can reduce the traffic and labor cost. Besides, parts of the design shoe sample, especially the parts such as soles which require mechanical tests, can be printed with suitable materials. Therefore, the design shoe sample can represent the properties such as weight, flexibility or wear resistance of a real shoe.

If the outputting step is the simulating step, a dynamic performance of the design shoe model can be simulated for users to understand a behavior of the design shoe model in use. For example, it can simulate the change and bending of the structure of the design shoe model during running or walking.

If the outputting step is the virtual reality experiencing step, users can check the design shoe model in a virtual reality environment. The users can not only check the 3D construction of the design shoe model, but also observe the behavior of the design shoe model in use in the virtual reality environment in coordination with the aforementioned dynamically simulating method.

In summary, in the methods of the present disclosure, 3D scanning and texture mapping technologies are adopted. The structure and details of the shoe sample are highly restored and the modeling efficiency is enhanced. In addition, the part models with high quality are established through dividing the structural model and transferring the texture. The users can intuitively choose and assemble the part models when designing a new shoe, significantly reducing the technical threshold of designing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method of modeling part of shoe, comprising:
providing a shoe sample;
performing a modeling step to 3D-scan the shoe sample to establish a structural model;
performing a mapping step to shoot a plurality of shoe texture photos from the shoe sample, and to map the plurality of shoe texture photos to the structural model, so as to form a shoe model with a texture;
performing a dividing step to divide the structural model into at least two part prototypes according to the texture of the shoe model; and
performing a transferring step to transfer the texture of the shoe model to the at least two part prototypes to form at least two part models.

2. The method of modeling part of shoe of claim 1, further comprising performing a first repairing step before performing the mapping step, so as to repair the structural model.

3. The method of modeling part of shoe of claim 1, wherein performing the mapping step further comprises:
performing a structure-unwrapping step to 2D-unwrap the structural model to establish a structural layout;
performing a map-creating step to create a shoe texture map from the plurality of shoe texture photos and the structural layout; and
performing a map-pasting step to paste the shoe texture map to the structural model to form the shoe model.

4. The method of modeling part of shoe of claim 3, further comprising performing a map-repairing step after performing the map-pasting step, so as to repair the shoe texture map.

5. The method of modeling part of shoe of claim 3, wherein performing the transferring step is to transfer the shoe texture map to the at least two part prototypes to form the at least two part models.

6. The method of modeling part of shoe of claim 1, further comprising performing a second repairing step before performing the transferring step, so as to repair the at least two part prototypes.

7. The method of modeling part of shoe of claim 1, wherein the structural model is established from a point cloud in the modeling step.

8. The method of modeling part of shoe of claim 1, further comprising performing an organizing step to number, categorize and save each of the at least two part models and/or the shoe model into a database.

9. A method of shoe designing, comprising:
providing a database comprising a plurality of part models established from a plurality of shoe samples and comprising a plurality of shoe models, wherein the database is created by the method of modeling part of shoe of claim 8;
performing a designing step by choosing and assembling at least two of the part models which are suitable from the database, or by choosing one of the shoe models from the database and modifying the texture or a structure of the one of the shoe models, so as to form a design shoe model; and
performing an outputting step to output the design shoe model.

10. The method of shoe designing of claim 9, wherein the outputting step is a 3D-printing step to 3D print the design shoe model into a design shoe sample for users to check.

11. The method of shoe designing of claim 9, wherein the outputting step is a simulating step to simulate a dynamic performance of the design shoe model for users to understand a behavior of the design shoe model in use.

12. The method of shoe designing of claim 9, wherein the outputting step is a virtual reality experiencing step for users to check the design shoe model in a virtual reality environment.

13. The method of shoe designing of claim 9, further comprising performing a modifying step before performing the outputting step, so as to modify a texture or a structure of the design shoe model.
